(19) United States
(12) Patent Application Publication
(10) Pub. No.: US 2009/0284521 A1
(43) Pub. Date: Nov. 19, 2009

(54) PLASMA DISPLAY DEVICE

(75) Inventors: Kenichi YAMAMOTO, Higashimurayama (JP); Keizo Suzuki, Kodaira (JP); Hiroshi Kajiyama, Fuchu (JP); Shirun Ho, Tokyo (JP); Tomokatsu Kishi, Yamato (JP); Kyoji Kariya, Yokohama (JP)

Correspondence Address: MILES & STOCKBRIDGE PC, 1751 PINNACLE DRIVE, SUITE 500, MCLEAN, VA, 22102-3833, US

(73) Assignees: HITACHI, LTD.; FUJITSU HITACHI PLASMA DISPLAY LIMITED

(21) Appl. No.: 12/507,791

(22) Filed: Jul. 22, 2009

Related U.S. Application Data
(62) Division of application No. 10/217,566, filed on Aug. 14, 2002.

(30) Foreign Application Priority Data
Mar. 20, 2002 (JP) 2002-078284

(51) Int. Cl. G06F 3/038

(52) U.S. Cl. 345/213; 345/60

(57) ABSTRACT

A plasma display device of high luminous efficiency is provided. In a plasma display device for performing driving including at least an address period and a sustain-discharge period for emission display, the sustain-discharge period includes a pulse application period and an open period, a voltage of an electrode to which a relatively positive voltage is applied in a sustain-discharge electrode pair in a pulse application period immediately before the open period is set as Vsp, and the voltage of the other electrode is set as Vsn, Vsp-Vsn has a significantly negative value in the open period, and light is emitted by a discharge in the open period.

### BACKGROUND OF THE INVENTION

The present invention relates to a plasma display device using a plasma display panel (hereinbelow, called a PDP) and a method of driving the same. The invention is particularly effective at improving luminous efficiency by improving ultraviolet-production efficiency.

Recently, as a large, thin color display device, a plasma display panel device using a so-called ac-coplanar-discharge type PDP enters a mass production stage. The ac-coplanar-discharge type PDP as a short name denotes a PDP of a coplanar discharge type driven on an ac voltage.

FIG. 21 is a perspective view showing an example of a known ac-coplanar-discharge type PDP of a three-electrode structure. In the ac-coplanar-discharge type PDP shown in FIG. 21, two glass substrates, specifically, a front substrate 21 and a back substrate 28 are disposed so as to face each other, and a gap between the substrates is a discharge space 33. In the discharge space 33, a discharge gas is normally filled at a pressure of hundreds Torr. As the discharge gas, a mixture gas of He, Ne, Xe, Ar, or the like is generally used.

On the under face of the front substrate 21 as a display face, sustain-discharge electrode pairs for performing a sustain discharge mainly for display emission are formed. Each sustain electrode pair consists of an X electrode and a Y electrode. Usually, each of the X and Y electrodes is constructed by a transparent electrode and an opaque electrode for compensating conductivity of the transparent electrode. Specifically, X electrodes 34-1, 34-2, . . . are constructed by X transparent electrodes 22-1, 22-2, . . . and opaque X-bus electrodes 24-1, 24-2, . . . , respectively. Y electrodes 35-1, 35-2, . . . are constructed by Y transparent electrodes 23-1, 23-2, . . . and opaque Y bus electrodes 25-1, 25-2, . . . , respectively. In many cases, the X electrode is used as a common electrode, and the Y electrode is used as independent electrode. Usually, a discharge gap Ldg between the X and Y electrodes is designed to be narrow so that a firing voltage does not become high, and an adjacent gap Lng is designed to be wide so as to prevent incorrect discharge with a neighboring discharge cell.

The sustain-discharge electrodes are covered with a front dielectric 26. On the surface of the dielectric 26, a protective film 27 made of magnesium oxide (MgO) or the like is formed. Since MgO has high sputtering resistance and a high secondary-electron-emission coefficient, MgO protects the front dielectric 26 and decreases the firing voltage.

On the other hand, on the top face of the back substrate 28, address electrodes (also called address discharge electrodes or A-electrodes) 29 for an address discharge are provided in the direction orthogonal to the sustain electrodes (X and Y electrodes). The A-electrodes 29 are covered with a back dielectric 30. Ribs 31 are provided between the A-electrodes 29 on the back dielectric 30. Further, in depression regions formed by the wall faces of the ribs 31 and the top face of the back dielectric 30, a phosphor 32 is applied. In this configuration, the intersecting portion between the sustain electrode pair and the A-electrode corresponds to one discharge cell. Discharge cells are arranged two-dimensionally. In the case of color display, by using three kinds of discharge cells applied with phosphors of red, green, and blue as a set, one pixel is constructed.

FIG. 22 is a cross section of one discharge cell seen from the direction of an arrow D1 in FIG. 21. FIG. 23 is a cross section of one discharge cell seen from the direction of an arrow D2 in FIG. 21. In FIG. 23, the border of the cell is schematically indicated by broken lines. Reference numerals 3, 4, 5, and 6 in FIG. 23 indicate an electron, a positive ion, a positive wall charge, and a negative wall charge, respectively.

The operation of the PDP in this example will now be described.

The principle of light emission of the PDP is that a discharge is brought about by a pulse voltage applied across the X and Y electrodes and an ultraviolet ray generated from an excited discharge gas is converted into a visible ray by the phosphor.

FIG. 24 is a block diagram showing a basic configuration of the PDP display. A PDP (Plasma Display Panel, which will be also simply called a panel) 100 is assembled in a plasma display device 102. A driving circuit 101 receives a signal of a display screen from a video signal source 103, converts it to a drive voltage, and supplies the drive voltage to each of electrodes of the PDP 100. FIGS. 25A to 25C show a concrete example of the drive voltage.

FIG. 25A is a time chart showing a drive voltage in a 1 TV field period required to display one picture onto the PDP shown in FIG. 21. FIG. 25B is a waveform chart of voltages applied the A electrode 29, X electrode 34, and Y electrode 35 in an address period (also called an address-discharge period) 50 of FIG. 25A. FIG. 25C is a diagram showing a sustain-drive pulse voltage (also called a sustain-discharge electrode pulse drive voltage) applied simultaneously across the X and Y electrodes as sustain-discharge electrodes, and a voltage applied to the address electrode during a sustain-discharge period (also called a luminous display period) 51 of FIG. 25A.

One TV field period 40 is divided into sub fields 41 to 48 having different numbers of light emission times. (I) in FIG. 25A shows this state.

Gray scale is expressed by selecting emission or non-emission in each sub field. For example, in the case of providing eight sub fields having weight of brightness with binary system, discharge cells for displaying three prime colors can display luminance of 2⁸ (=256) levels of gray scale, and about 16,780,000 colors can be displayed.

As shown in (II) in FIG. 25A, each sub field has the following three periods: a reset period (also called a reset discharge period) 49 for resetting the discharge cell to an initial state, an address period (also called an address-discharge period) 50 for selecting a discharge cell for light emission, and a sustain period (also called a sustain-discharge period, or an emission display period) 51.

FIG. 25B is a diagram showing the waveform of voltages applied to the A electrode 29, X electrode 34, and Y electrode 35 in the address period 50 of FIG. 25A. A waveform 52 is a waveform of a voltage (V0) applied to one A-electrode 29 in the address period 50. A waveform 53 is a waveform of a voltage (V1) applied to the X electrode 34. 54 and 55 indicate waveforms of voltages (V21 and V22) applied to the i-th Y electrode 35 and the (i+1)th Y electrode 35, respectively.

As shown in FIG. 25B, when a scan pulse 56 is applied to the i-th Y electrode 35, in a cell positioned at the intersecting point of the Y electrode 35 and the A-electrode 29 of the voltage V0, an address discharge occurs between the Y electrode and the A electrode and then between the Y electrode and the X electrode. In a cell positioned at the intersecting point between the Y electrode 35 and the A electrode 29 of the ground potential, no address discharge occurs. The case where a scan pulse 57 is applied to the (i+1) the Y electrode is similar to the above case.

In a discharge cell where the address discharge occurs, a charge (wall charge) generated by the discharge is formed on the surface of the dielectric film 26 and the protective film 27 covering the X and Y electrodes, and a wall voltage Vw(V) is generated between the X and Y electrodes. As described above, reference numerals 3, 4, 5, and 6 in FIG. 23 indicate electron, positive ion, positive wall charge, and negative wall charge, respectively. The presence or absence of the wall charge determines the presence or absence of a sustain discharge in the following sustain discharge period 51.

FIG. 25C is a diagram showing sustain pulse voltages applied simultaneously across X and Y electrodes as sustain discharge electrodes during the sustain-discharge period 51 in FIG. 25A. The sustain discharge pulse voltage of the voltage waveform 58 is applied to the X electrode, and the sustain-discharge pulse voltage of the voltage waveform 59 is applied to the Y electrode. The voltage value of each of the voltages is V3 (V). A drive voltage having the voltage waveform 60 is applied to the A-electrode 29, and is held at a predetermined voltage (V4) in the sustain-discharge period. The voltage V4 may be a ground potential. By alternate application of the sustain discharge pulse voltage of V3, relative voltages of the X and Y electrodes repeat inversion. The voltage value of V3 is set so that the presence or absence of the sustain discharge is determined by the presence or absence of the wall voltage generated by the address discharge.

In the first voltage pulse of the discharge cell in which the address discharge occurs, the discharge continues until wall charges of the opposite polarity are accumulated to some extent. As a result of the discharge, the accumulated wall voltage acts in the direction of supporting the second voltage pulse which is inverted, and a discharge occurs again. The third and subsequent pulses act similarly. Between the X and Y electrodes of the discharge cell in which the address discharge occurs, a sustain discharge of an amount corresponding to the number of pulses of an applied voltage occurs, and light emits. On the contrary, a discharge cell in which no address discharge occurs does not emit light. The above is the basic configuration of a normal PDP device and the method of driving the device.

Main techniques related to a driving method which improves luminous efficiency are as follows.

(1) Japanese Patent Laid-open No. Hei 11-65514. According to this technique, in an application voltage waveform for generating a sustain discharge, a low voltage is applied and, after that, a high voltage sufficient to bring about a sustain discharge is applied for long time. However, the low voltage applied is a non-discharge pulse limited to the range of generating no discharge light emission and is used only for a priming effect.
(2) Japanese Patent Laid-open No. Hei 2001-13919. According to the technique, a first voltage source is connected to an X electrode via an inductance element, and a sustain-discharge pulse generating circuit having a switch for applying a priming pulse of a higher crest value than the first voltage source, and a switch for applying a second voltage lower than the crest value is provided. However, the pulse is generated by the inductance element use only the priming effect.

The feature of the related arts is that, although a voltage is applied in two stages to the sustain-discharge electrode, a discharge accompanying light emission is only once at the time of applying the pulse in the second stage. That is, there is no technique using a discharge accompanying light emission between the sustain-discharge electrodes in the pulse of the first stage of the sustain-discharge pulses of at least the two stages and using the inductance element to bring about a discharge accompanying light emission in the first stage.

### SUMMARY OF THE INVENTION

At present, one of the most important subjects to spread a PDP for a television (TV) is improvement in luminous efficiency.

An object of the invention is to provide a technique of improving luminous efficiency of a sustain discharge by devising a driving method in a plasma display device using a plasma display panel.

First, the basic mechanism of improving luminous, efficiency supporting the driving principle of the invention will be described. The basic physical principle of higher luminous efficiency is that, since an electron temperature decreases in a discharge of a weak electric field (low-discharge-space voltage), the ultraviolet-production efficiency increases. When the ultraviolet-production efficiency increases, the luminous efficiency naturally increases. Therefore, the basis of the technique is to decrease the discharge space voltage at the time of a discharge. The discharge space voltage is an absolute value of the difference between the dielectric surface potential of the X electrode and that of the Y electrode, which is a voltage actually applied in the discharge space. That is, the discharge space voltage is a sum of the voltage applied across the sustain-discharge electrodes and the wall voltage generated in the dielectric of the X and Y electrodes. The relation itself between the discharge space voltage and the ultraviolet production is known for example, in Journal of Applied Physics, Vol. 88, No. 10, pp. 5605-5611 (Nov. 15, 2000).

The basic ideas of the invention are as follows.

(1) To perform a sustain discharge in at least two stages (hereinbelow, called two-stage sustain discharge) of a pre-discharge performed during an open period and a main discharge performed subsequent to the pre-discharge.
(2) To realize the two-stage sustain discharge by using the characteristic of a sustain-discharge voltage waveform.

A period in which a desired external voltage is applied to the sustain-discharge electrode is called a pulse application period (also called a sustain-pulse-applied period), and the other sustain-discharge period will be called an open period (also called a sustain-pulse-open period). Therefore, the discharge space voltage in the pre-discharge is mainly a wall voltage (which is generated by the immediately preceding discharge), and a high luminous efficiency discharge with a low-discharge-space voltage is realized. Further, in the main discharge subsequent to the pre-discharge, the wall voltage drops by the pre-discharge, so that the main discharge of higher luminous efficiency with a lower-discharge-space voltage as compared with the related arts is realized. The main discharge occurs with the low-discharge-space voltage for the reason that space charges generated by the pre-discharge produce the priming effect.

In the invention, to bring about a pre-discharge with the low-discharge-space voltage, a proper external voltage is applied across sustain electrodes in the open period. The proper external voltage denotes a voltage realizing the stable two-stage discharge and high luminous efficiency (realizing the low-discharge-space voltage).

Further, the invention also includes a form of using an inductance element connected to the sustain-discharge electrode to realize the proper external voltage in the open period. For the following description, falling and rising of the sustain-discharge pulse voltage are defined as follows. A change in the sustain-discharge pulse voltage at the start of the open period is called a falling, and a change in the sustain-discharge pulse voltage at the end of the open period is called a rising.

Outlines of representative inventions disclosed in the application will be described as follows.

The essence of the invention relates to a plasma display device as described below.

(1) A plasma display device comprising a plasma display panel having, as components, at least a plurality of discharge cells each including at least a pair of sustain-discharge electrodes,

wherein driving including at least an address period and a sustain-driving period for emission display is performed,

a sustain-discharge pulse voltage is applied to at least one of the sustain-discharge electrodes in a pair during the sustain-discharge period,

in the sustain-discharge period, at least a pre-discharge and a main discharge which occurs subsequent to the pre-discharge occur, and

the sustain-discharge pulse includes at least a voltage level for the pre-discharge and a voltage level for the main discharge.

(2) A plasma display device comprising a plasma display panel having, as components, at least a plurality of discharge cells each including at least a pair of sustain-discharge electrodes,

wherein driving including at least an address period and a sustain-driving period for emission display is performed,

a sustain-discharge pulse voltage is applied to at least one of the sustain-discharge electrodes in a pair in each of the plurality of discharge cells during the sustain-discharge period,

the sustain-discharge period includes a pulse application period and an open period,

in the pulse application period just before the open period, when a voltage of an electrode to which a relatively positive voltage is applied in the sustain-discharge electrode pair is Vsp, and the voltage of the other electrode is Vsn,

Vsp-Vsn has a significantly negative value in the open period, and

discharge emission can be performed in the open period.

(3) The plasma display device according to (1) or (2), wherein the difference (called an amplitude of Vsp-Vsn) between the maximum value and the minimum value of the Vsp-Vsn in the period of a half cycle of the sustain-discharge pulse having the pulse application period and the open period becomes equal to or higher than a firing voltage between the sustain-discharge electrode pair.
(4) The plasma display device according to (1) or (2), wherein emission intensity of the main discharge is at least higher than emission intensity of the pre-discharge.
(5) The plasma display device according to (1), wherein a voltage level for the pre-charge is achieved by providing the inductance element.
(6) The plasma display device according to (2), wherein means for allowing Vsp-Vsn to have significantly a negative value in the open period has an inductance element.
(7) A form which does not use an inductance element at the rising edge of a pulse can be used. The plasma display device according to (5) or (6), wherein no current flows through the inductance element at the rising edge of the sustain-discharge pulse.
(8) The plasma display device according to (2), wherein in the open period, a voltage of the same sign as that of the sustain-discharge electrode 1 in the pulse application period just before the open period is applied to the sustain-discharge electrode 2 different from the sustain-discharge electrode 1 having a falling edge of the sustain-discharge pulse voltage.
(9) The plasma display device according to (1) or (2), wherein the sustain pulses applied to the pair of sustain-discharge electrodes in the sustain-discharge period are pulses having at least a 0V level and a Vs level, and are deviated in phase from each other by a half cycle.
(10) The plasma display device according to (1) or (2), wherein in the sustain-discharge period, the sustain-discharge pulses applied to the pair of sustain-discharge electrodes are pulses having at least a −Vs level and a +Vs level, and are deviated in phase from each other by a half cycle.

These and other objects and many of the attendant advantages of the invention will be readily appreciated as the same becomes better understood by reference to the following detailed description when considered in connection with the accompanying drawings.

### BRIEF DESCRIPTION OF THE DRAWINGS

FIGS. 1A and 1B are diagrams showing a voltage waveform of a PDP of a plasma display device according to a first embodiment of the invention and a waveform of light emission of Xe 828 nm.

FIG. 2 is a diagram showing the basic configuration of the PDP of the plasma display device according to the first embodiment of the invention.

FIG. 3 is a diagram showing a sustain-discharge pulse generating circuit of the plasma display device according to the first embodiment of the invention.

FIG. 4 shows an operation waveform of the sustain-discharge pulse generating circuit of the plasma display device of the first embodiment of the invention.

FIG. 5 shows an equivalent circuit of the sustain-discharge pulse generating circuit.

FIG. 6 is a block diagram showing a schematic configuration of an example of a plasma display device according to a fourth embodiment of the invention.

FIG. 7 shows a drive voltage waveform of a conventional driving method.

FIGS. 8A to 8C are diagrams showing dielectric surface potential models at time a, b, and c in FIG. 7.

FIG. 9 shows a drive voltage waveform of the first embodiment.

FIGS. 10A to 10C are diagrams showing models of surface dielectric potentials at time a, b1, b2, and c of FIG. 9.

FIG. 11 shows another example of the sustain-discharge pulse waveform of the first embodiment of the invention.

FIG. 12 shows a sustain-discharge pulse generating circuit of the plasma display device of the second embodiment of the invention.

FIG. 13 shows an operation waveform of a sustain-discharge pulse generating circuit of the second embodiment.

FIG. 14 shows a sustain-discharge pulse generating circuit of a plasma display device of a third embodiment of the invention.

FIG. 15 shows an operation waveform of the sustain pulse generating circuit of the third embodiment.

FIG. 16 shows a waveform of another sustain-discharge pulse voltage of the third embodiment of the invention.

FIG. 17 shows a waveform of the sustain-discharge pulse voltage of the PDP of a plasma display device of the fourth embodiment of the invention.

FIG. 18 shows a waveform of another sustain-discharge pulse voltage of the embodiment.

FIG. 19 shows a waveform of another sustain-discharge pulse voltage of the embodiment.

FIG. 20 shows a waveform of a sustain-discharge pulse voltage of a PDP of a plasma display device of a fifth embodiment of the invention.

FIG. 21 is a perspective view showing an example of a known ac-coplanar-discharge type PDP of a three-electrode structure.

FIG. 22 is a cross section of a plasma display panel seen from the direction of an arrow D1 in FIG. 21.

FIG. 23 is a cross section of a plasma display panel seen from the direction of an arrow D2 in FIG. 21.

FIG. 24 is a block diagram showing a basic configuration of a conventional plasma display device.

FIGS. 25A to 25C are diagrams for explaining the operations of a drive circuit in a 1 TV field period of displaying an image on a plasma display panel.

FIGS. 26A and 26B are diagrams showing a voltage waveform of a PDP of a conventional plasma display device and an emission waveform of an Xe 828 nm.

FIGS. 27A to 27C are diagrams showing models of a dielectric surface potential of the fourth embodiment.

FIG. 28 shows a waveform of another sustain-discharge pulse voltage of a PDP of the plasma display device of the fifth embodiment of the invention.

### DETAILED DESCRIPTION OF THE PREFERRED EMBODIMENTS

Embodiments of the invention will be described in detail hereinbelow with reference to the drawings. In all of the drawings for explaining the embodiments, components having the same function are designated by the same reference numeral and the description will not be repeated.

### First Embodiment

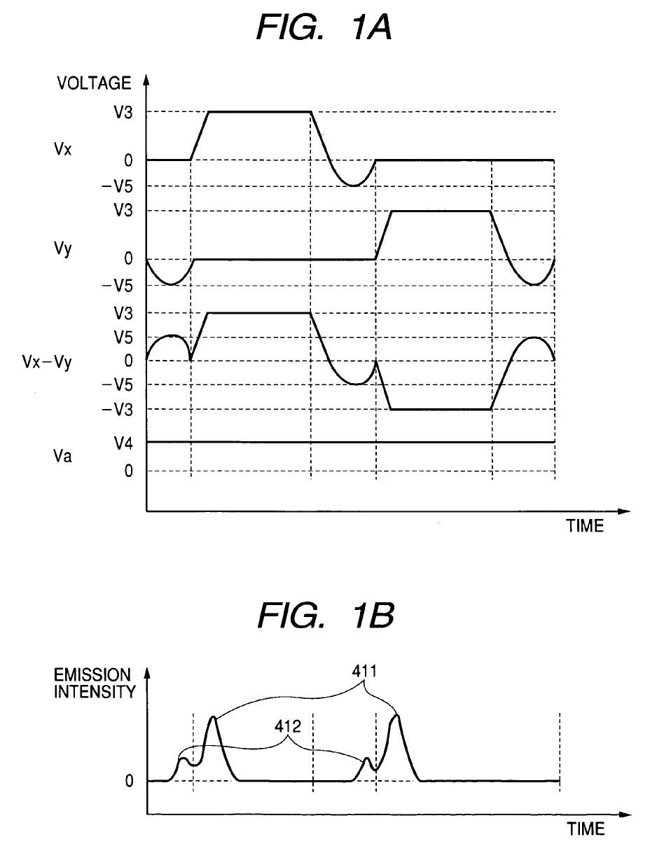

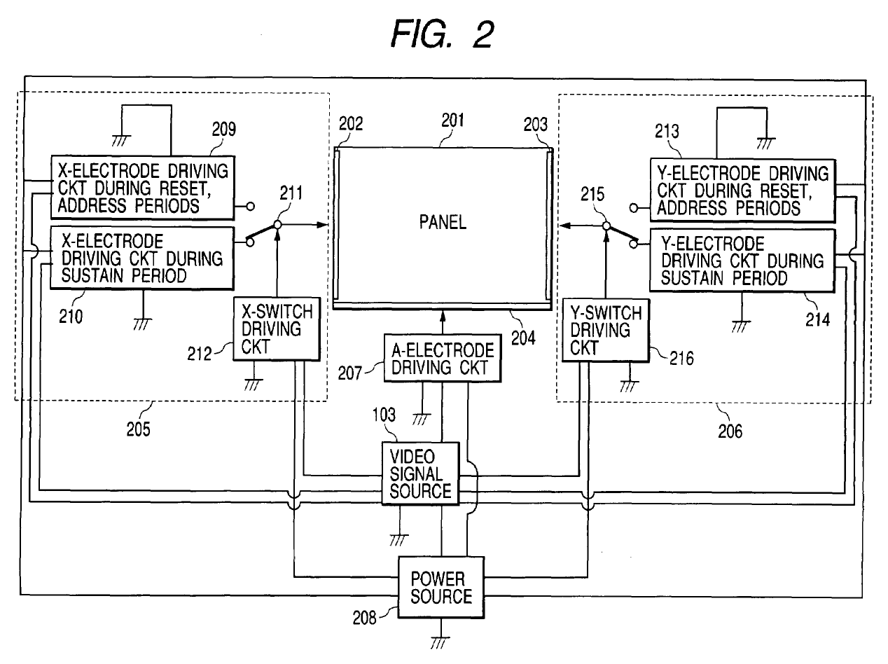

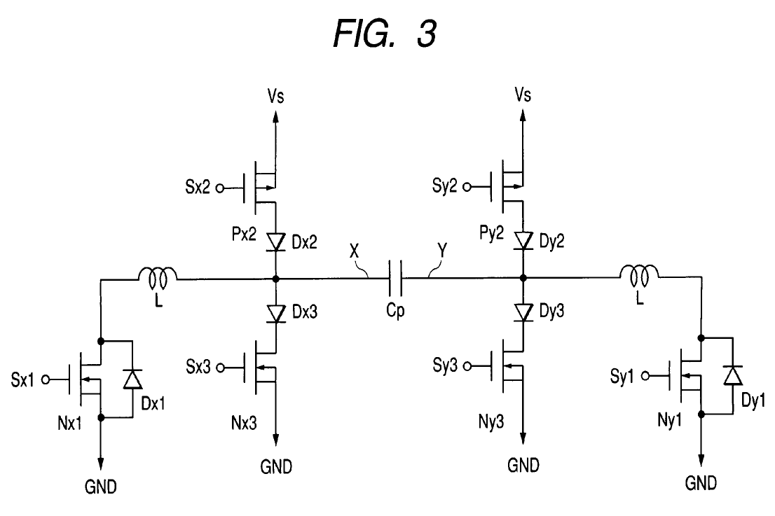

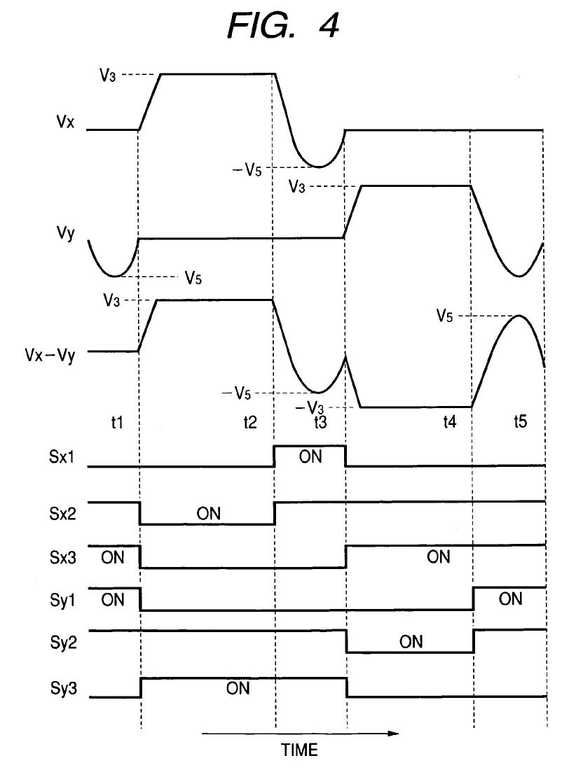

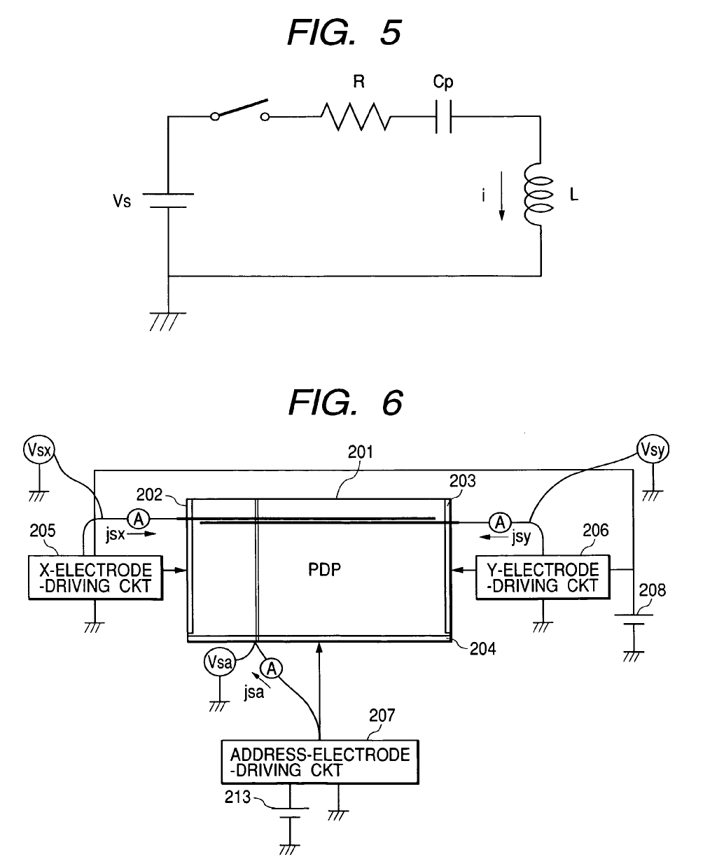

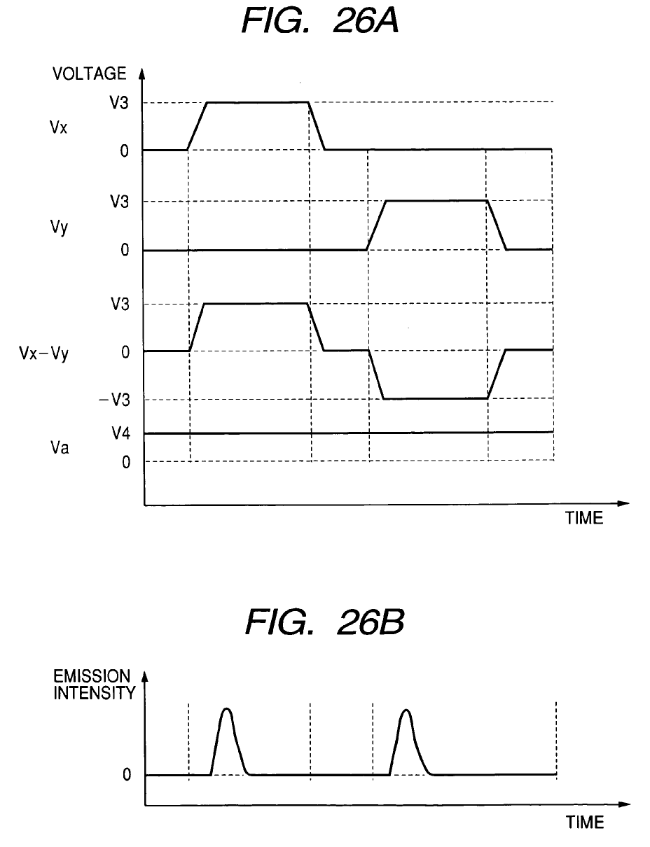

FIGS. 1A and 1B are diagrams showing a voltage waveform of a PDP of a plasma display device according to a first embodiment of the invention and a waveform of emission of Xe 828 nm (emission having a wavelength of 828 nm from excited Xe atoms), respectively. The same time base as the horizontal line is used for the diagrams of FIGS. 1A and 1B. FIG. 2 is a diagram showing the basic configuration of the PDP of the plasma display device according to the first embodiment of the invention. FIG. 3 is a diagram showing a sustain-discharge pulse generating circuit of the plasma display device according to the first embodiment of the invention. FIG. 4 shows an operation waveform of the sustain-discharge pulse generating circuit. FIG. 5 shows an equivalent circuit of the sustain-discharge pulse generating circuit. FIGS. 26A and 26B are diagrams showing a voltage waveform of a PDP of a conventional plasma display device and an emission waveform of an Xe 828 nm, respectively. FIGS. 26A and 26B will be referred to for comparison with the embodiment.

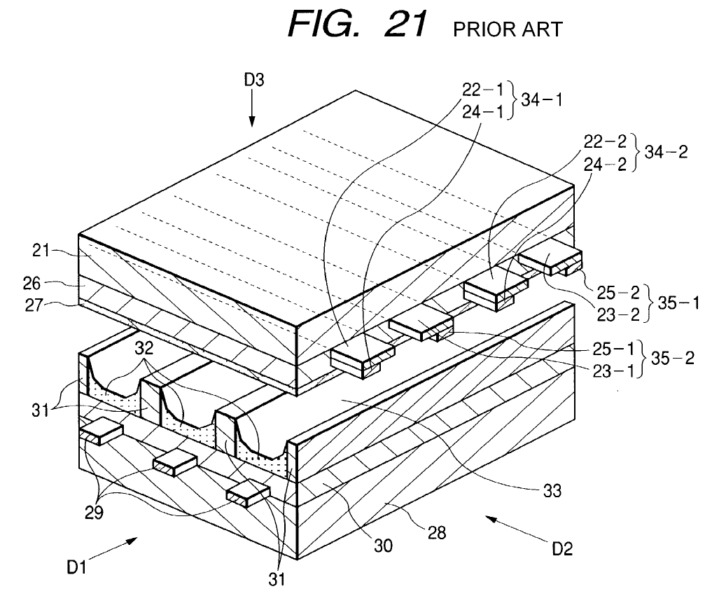

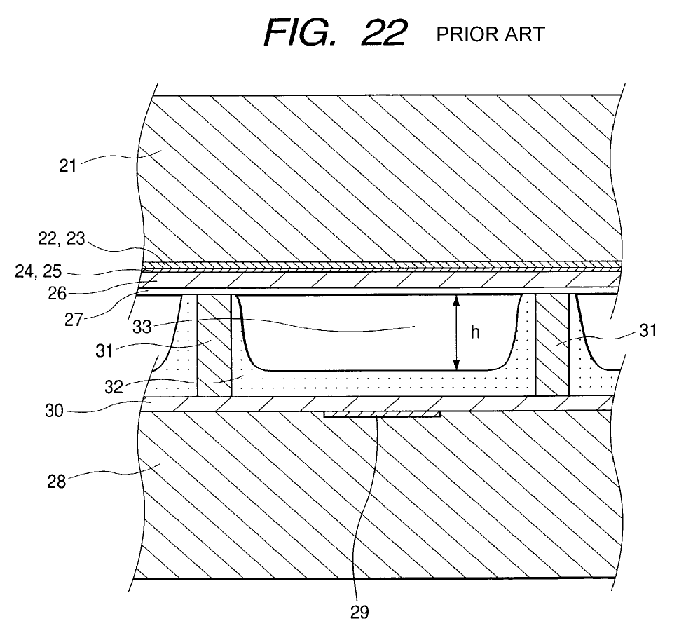

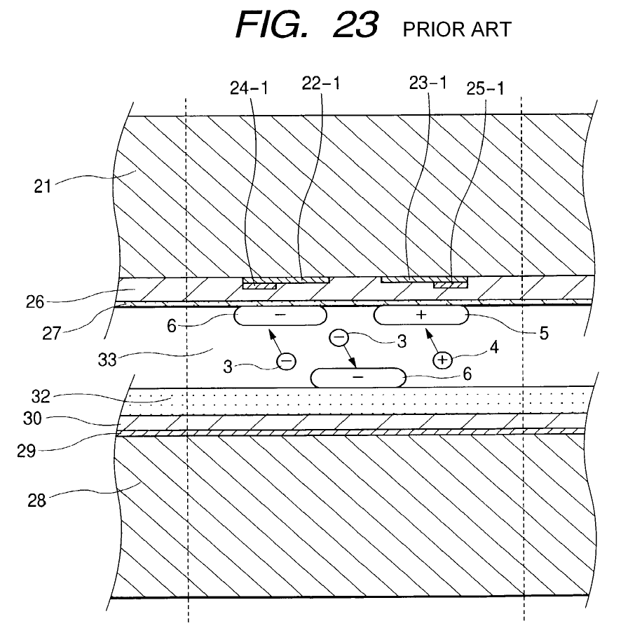

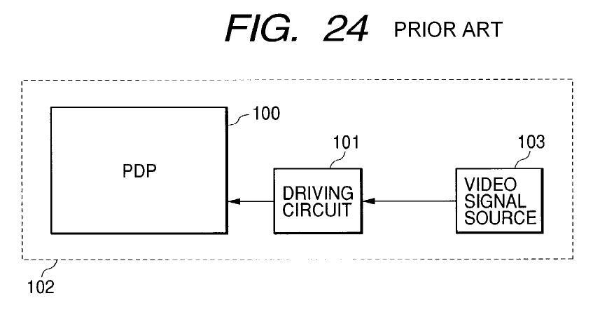

The basis configuration of the plasma display device of the embodiment is as follows. Specifically, as shown in FIG. 2, the PDP of the first embodiment includes: a panel 201 constructed by discharge cells each having a structure similar to that of FIG. 21 of the conventional technique; an X-electrode terminal part 202, a Y-electrode terminal part 203, and an A-electrode terminal part 204 which are connection parts between the electrode group in the panel and external circuits; an X-electrode driving circuit 205, a Y-electrode driving circuit 206, and an A-electrode driving circuit 207 for driving the parts 202, 203, and 204, respectively; a video signal source 103 for supplying a video signal of the display screen to the driving circuits 205, 206, and 207; and a power source circuit 208 for supplying power to the driving circuits 205, 206, and 207 and the video signal source 103. The X-electrode driving circuit 205 has an X-electrode driving circuit during reset, address periods 209, an X-electrode driving circuit during sustain-discharge period 210, a switch 211 for switching the circuits 209 and 210 at a proper timing, and an X-switch driving circuit 212 for controlling the switch 211. The Y-electrode driving circuit 206 has a Y-electrode driving circuit during reset, address periods 213, a Y-electrode driving circuit during sustain-discharge period 214, a switch 215 for switching the circuits 213 and 214 at a proper timing, and a Y-switch driving circuit 216 for controlling the switch 215. CKT in FIG. 2 and thereafter means circuit.

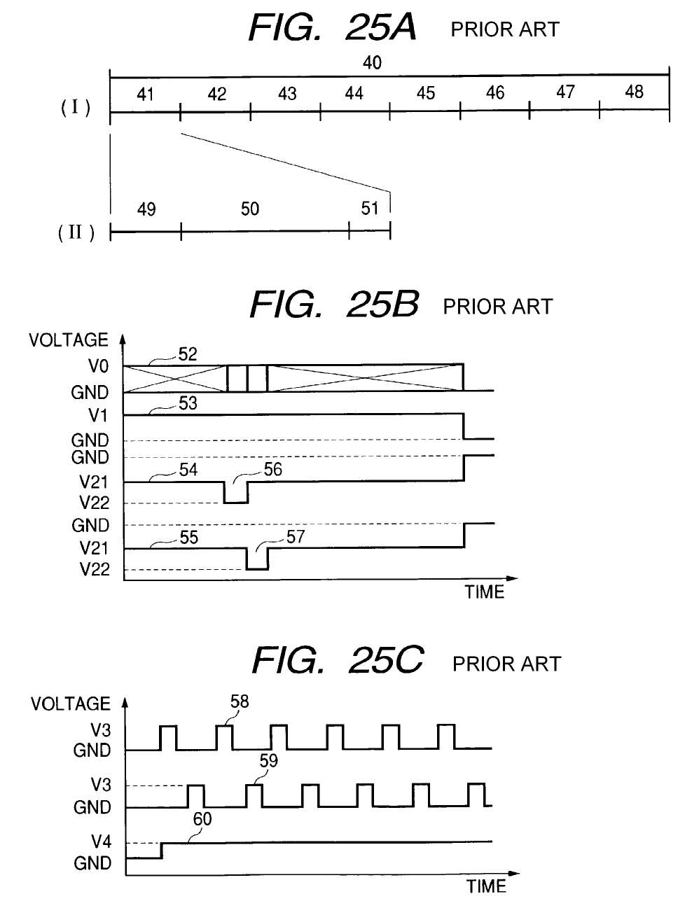

A method of driving the plasma display device of the embodiment will be described by referring to FIGS. 25A to 25C, 1, and 2. The basis of the driving method in the 1 TV field period of the PDP is similar to that shown in FIGS. 25A to 25C. To be specific, each sub field consists of, as shown in (II) of FIG. 25A, the reset period 49 for resetting the discharge cell to the initial state, the address period 50 for selecting a discharge cell which emits light, and the sustain discharge period 51 for allowing the selected discharge cell to emit light.

The discharge period includes at least an address period and a sustain discharge period in which a sustain discharge is brought about for light emission display. In the address period, first, on the basis of the signal from the video signal source 103 of FIG. 2, the switches 211 and 215 are connected to the X-electrode driving circuit during reset, address periods 209 and the Y-electrode driving circuit during reset, address periods 213 by the X-switch driving circuit 212 and the Y-switch driving circuit

216, respectively. Next, according to the signal of the video signal source 103, by the A-electrode driving circuit 207 and the X- and Y-electrode driving circuits during reset, address periods 209 and 213, an address discharge is brought about in a desired discharge cell to emit light and a wall voltage Vw (V) is generated between the X and Y electrodes of the desired discharge cell. By the above operation, a discharge cell which emits light during the sustain discharge period and a discharge cell which does not emit light are selected. By applying a voltage to a degree at which a discharge occurs only when the wall voltage is generated between the X and Y electrodes 34 and 35 during the sustain discharge period, only a desired discharge cell emits light for display.

During the sustain discharge period 51, the switches 211 and 215 are connected to the sustain-period X- and Y-electrode driving circuits 210 and 214 sides, respectively. FIG. 1A shows the voltage waveform of a sustain-discharge pulse simultaneously applied to the X- and Y-electrodes during the sustain-discharge period 51, and the waveform of the address voltage which is the constant voltage V4 applied to the A-electrode 29. In FIG. 1A, Vx and Vy denote sustain-discharge pulse voltages applied to the X- and Y-electrodes, respectively. Vx-Vy denotes a difference of the voltages Vx and Vy, that is, a voltage between the X- and Y-electrodes. FIG. 1B shows the emission waveform of the Xe 828 nm in the sustain discharge period. The emission waveform has a plurality of peaks including the pre-discharge 412 before the main discharge 411.

The different points between the plasma display device of the first embodiment of the invention and the conventional plasma display device are as follows.

According to the related art, as shown in FIG. 25C, the sustain discharge pulse voltages having rectangular voltage waveforms 58 and 59 of the peak voltage V3 are applied to the X- and Y-electrodes 34 and 35 during the sustain-discharge period. Alternately, considering the rising and falling edges of the pulse, the sustain discharge pulse voltage as shown in FIG. 26A is applied. At this time, the sum of the maximum value of the absolute value of Vx-Vy in a pulse application period and the maximum value of the absolute value of Vx-Vy in a period in which Vx-Vy has a sign opposite to that in the pulse application period or becomes 0V significantly in the open period is about the peak value V3 of the sustain discharge pulse voltage. In another expression, the difference (called the amplitude of Vx-Vy) between the maximum value and the minimum value of Vx-Vy in the period of a half cycle of the sustain discharge pulse consisting of the pulse application period and the open period is about the peak value V3 of the sustain discharge voltage. At this time, usually, the emission waveform having a single peak as shown in FIG. 26B (for example, emission waveform of Xe 828 nm) is obtained.

In contrast, according to the first embodiment of the invention, the sustain-discharge pulse voltage shown in FIG. 1A is applied to the X and Y electrodes 34 and 35 within the sustain-discharge period. Different from the related art, the sum of the maximum value of the absolute value of Vx-Vy of a pulse application period and the maximum value of the absolute value of Vx-Vy in a period in which Vx-Vy has a sign opposite to that in the pulse application period or becomes 0V significantly in the open period is V3+V5 which is significantly equal to or higher than the peak value V3 of the sustain-discharge pulse voltage. In another expression, the difference (called the amplitude of Vx-Vy) between the maximum value and the minimum value of Vx-Vy in the period of a half cycle of the sustain discharge pulse consisting of the pulse application period and the open period becomes equal to or higher than the peak value V3 of the sustain discharge pulse voltage. At this time, as described above, the voltage has the waveform of light emission (for example, the light emission waveform of Xe 828 nm) having a plurality of peaks including the pre-discharge 412 before the main discharge 411 as shown in FIG. 1B. The voltage V5 is set so that the pre-discharge 412 occurs and the main discharge also occurs.

First, the conditions of generating the pre-discharge are that the sum between the maximum value of the absolute value of Vx-Vy in a pulse application period and the maximum value of the absolute value of Vx-Vy in a period in which Vx-Vy has a sign opposite to that in the pulse application period or becomes 0V significantly in the open period is V3+V5, and the sum V3+V5 becomes equal to or higher than the firing voltage across the sustain discharge electrode pair. In another expression, the amplitude of Vx-Vy in the period of the half cycle of the sustain discharge pulse consisting of the pulse application period and the open period becomes equal to or higher than the firing voltage across the sustain discharge electrode pair.

To bring about the pre-discharge 412 and the main discharge 411, at least, emission intensity of the main discharge 411 has to be higher than that of the pre-discharge 412.

A concrete circuit of the sustain-discharge pulse generating circuit will now be described. FIG. 3 shows a sustain-discharge pulse generating circuit of the first embodiment. The circuit is a concrete circuit regarding driving of the X- and Y-electrodes in the sustain discharge period in the basic configuration shown in FIG. 2. FIG. 3 shows an example of a concrete circuit of the basic configuration constructed by the panel 201, sustain period X- and Y-electrode driving circuits 210 and 214, video signal source 103, and power source circuit 208 of FIG. 2. The panel 201 is expressed by capacity Cp between the X- and Y-electrodes of the sustain discharge electrodes. The X-electrode driving circuit has a P-type transistor Px2 connected to the voltage source Vs, N-type transistors Nx1 and Nx3 connected to the ground, an inductance element L, and diodes Dx1, Dx2, and Dx3. Similarly, the Y-electrode driving circuit has a P-type transistor Py2 connected to the voltage source Vs, N-type transistors Ny1 and Ny3 connected to the ground, an inductance element L, and diodes Dy1, Dy2, and Dy3.

FIG. 4 is an operation waveform chart of the sustain-discharge pulse generating circuit of the first embodiment. Vx denotes the voltage waveform of the X electrode, Vy expresses the voltage waveform of the Y electrode, and Vx-Vy indicates the waveform of the voltage between the X and Y electrodes (waveform of the voltage difference). Sx1 to Sx3 and Sy1 to Sy3 express waveforms of control signals. Reference numeral indicates the waveform of a voltage at each terminal in FIG. 3. With reference to FIG. 4, the operation of FIG. 3 will be described.

At time t1, Sx2 goes low and the transistor Px2 is made conductive and connected to the voltage source Vs via the diode Dx2. Consequently, Vx becomes a set voltage V3 of the voltage source Vs with a time constant determined by Cp, resistance of wiring or the like. At this time, Sy3 goes high and the transistor Ny3 is made conductive and connected to the ground, so that Vy becomes the ground potential. At time t2, Sx1 goes high, and the transistor Nx1 is made conductive and connected to the ground via the inductance element L. At this time, Sy3 also goes high, and the transistor Ny3 is made conductive and connected to the ground. Therefore, by using R as a resistor in the wiring or the like, an LCR series circuit of FIG. 5 is formed. In this case, the voltage Vx(t) of the X electrode is expressed by the following expressions of damped oscillation.

$$Vx ( t ) = {V}_{0 \times {e}^{- t / ( 2 L / R )}} \times \frac{sin ( \sqrt{1 / LCp - {( R / 2 L )}^{2}} t + θ )}{sin θ}$$

$$θ = {tan}^{- 1} [ ( 2 L / R ) \sqrt{1 / LCp - {( R / 2 L )}^{2}} ]$$

Therefore, by adjusting the amplitude and cycle by L, the sustain discharge voltage waveform as shown in FIG. 1A can be obtained. Since the operations at time t3 and t4 are similar to those at time t1 and t2 except that X and Y are replaced with each other, their description will not be repeated.

FIG. 6 shows a system for measuring the voltage and current waveforms of the X, Y, and A electrodes. A voltage waveform is obtained by measuring wire exposed portions between the X-electrode terminal part 202, Y-electrode terminal part 203, and A-electrode terminal part 204 and the driving circuits 205, 206, and 207, respectively by using an oscilloscope. A current waveform is measured by an oscilloscope by connecting a current probe to a wire between each electrode to the corresponding driving circuit. The direction of measuring each current is set so that the current becomes positive when passed to each electrode from the outside of the panel 201.

In a state W (white pattern) in which a predetermined discharge cell group in the address period 50 is selected and a state B (black pattern) which is the same as the state W except for the predetermined discharge cell group and in which the predetermined discharge cell group is not selected, the waveforms of voltages at the sustain-discharge electrodes 1 and 2 and the A-electrode are expressed as Vs1W(t), Vs2W(t), and VsaW (t), and Vs1B (t), Vs2B (t), and VsaB (t). Current waveforms are expressed as js1W(t), js2W(t), js1B(t), js2B(t), and jsaB(t). The sustain-discharge electrode 1 is an electrode (in this case, Y electrode) which has the positive potential relative to the other electrode in the sustain-discharge electrode pair immediately after the open period, and the other X-electrode is the sustain-discharge electrode 2.

First, discharge power, brightness, and efficiency of the driving method according to the invention and those of the conventional driving method are compared with each other. A discharge power W is calculated by the following integration of one cycle.

$$W = ∮ ( j s 1 W ( t ) \cdot Vs 1 W ( t ) + j s 2 W ( t ) \cdot Vs 2 W ( t ) + j saW ( t ) \cdot VsaW ( t ) ) d t$$

The brightness B is measured by a brightness meter, and luminous efficiency η∝B/W is calculated from W and B.

According to the conventional driving method, driving is performed with the sustain-discharge voltage V3=180V and the address electrode voltage V4=90V in the sustain-discharge period.

In contrast, according to the driving method of the invention, driving is performed with V3=180V, V5=60V, and the address electrode voltage V4=90V in the sustain-discharge period. The ratio of each of discharge light emission characteristics (the value in the driving method of the invention/the value in the conventional driving method) is as follows. The discharge power ratio is 0.86, the brightness ratio is 1.12, and the luminous efficiency is 1.30. It is understood from the above that, as compared with the conventional method, according to the invention, the luminous efficiency is improved by about 30%.

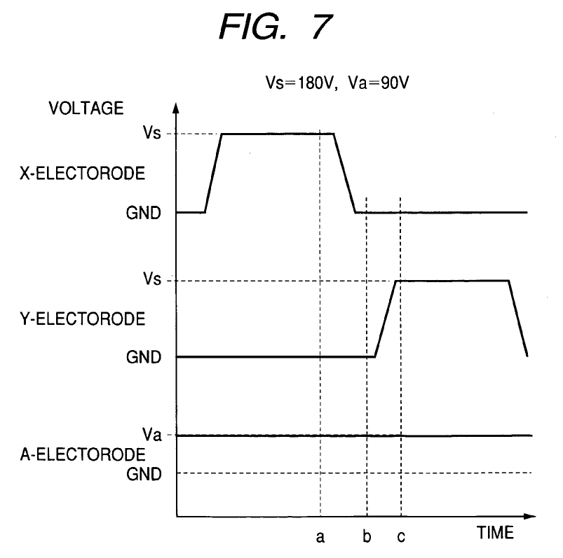

The discharge and the mechanism of improving the luminous efficiency by the invention will be described by using dielectric surface potential models shown in FIGS. 7 to 10. The basic principle of higher efficiency is, as already described above, due to decrease in the temperature of electrons in a discharge of a weak electric field (low-discharge-space voltage), the ultraviolet-production efficiency increases.

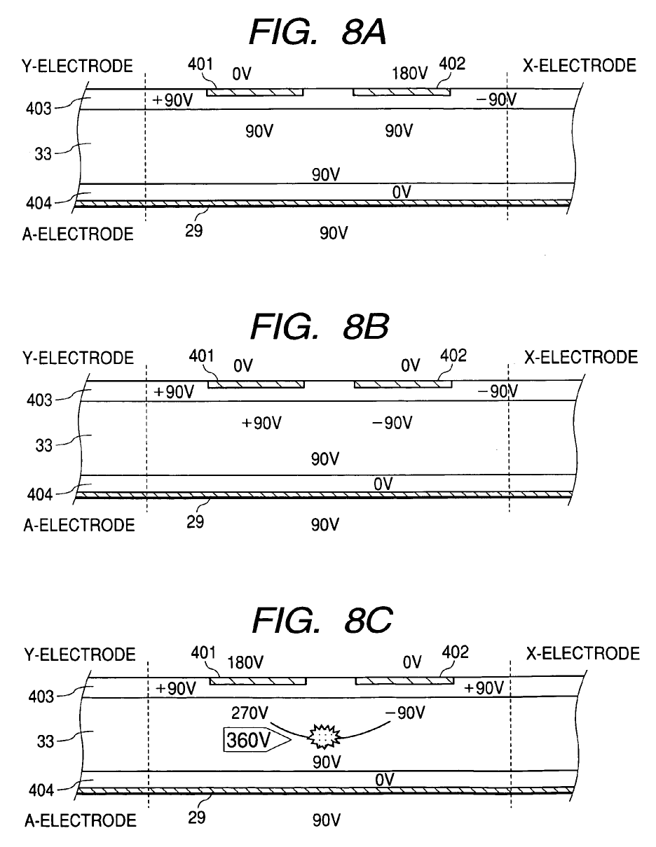

FIG. 7 shows a waveform of a drive voltage of the conventional driving method, and FIGS. 8A, 8B, and 8C are diagrams showing dielectric surface potential models at time a, b, and c in FIG. 7. It is assumed that the voltage Vs of the sustain-discharge electrodes X and Y is equal to Vsx=Vsy=180V, A-electrode voltage Va=90V, a discharge by the X-electrode voltage pulse is finished by time a, and the discharge is continued until no electric field exists in the discharge space. At this time, all of the dielectric surface potentials of the X, Y, and A electrodes are 90V. Between the X, Y, and A electrodes and the dielectric surface, a wall voltage shown in the diagrams is generated. At time b in the open period, the X-electrode voltage becomes 0V, so that the dielectric surface potential of the X-electrode is −90V of the amount corresponding to the wall voltage. At time c, the Y-electrode voltage becomes 180V, so that the potential of 270V is generated in the dielectric surface of the Y electrode. At this time, the potential difference between the X and Y electrode dielectric surfaces is 360V which is higher than the firing voltage (about 230V), so that a coplanar discharge occurs. Since the potential difference between the dielectric surfaces of the X and A electrodes is 180V and is lower than the firing voltage (about 210V), no discharge occurs. Shown in FIGS. 8A to 8C are a discharge space 33, a sustain-discharge Y electrode 401, a sustain-discharge X electrode 402, and dielectric layers 403 and 404.

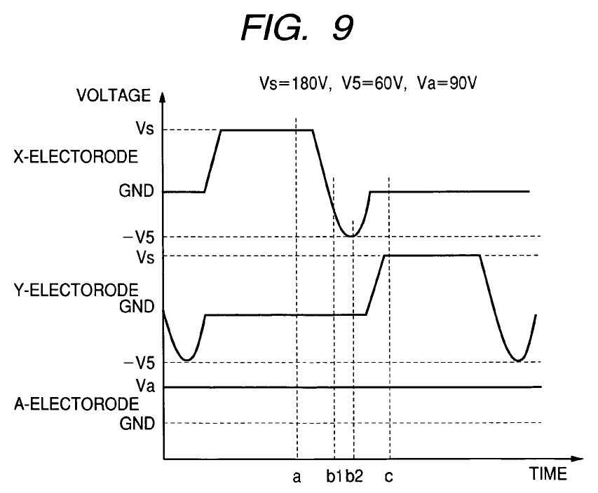

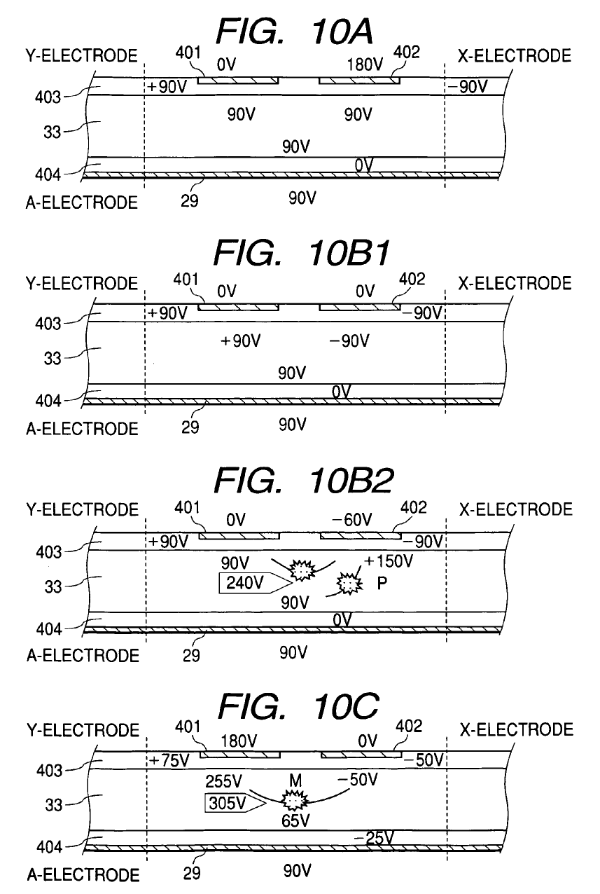

FIG. 9 shows the waveform of a drive voltage of the first embodiment and FIGS. 10A, 10B1, 10B2, and 10C are diagrams showing surface dielectric potential models at time a, b1, b2, and c, respectively.

At time a, in a manner similar to the conventional driving method, all of the dielectric surface potentials of the X, Y, and A electrodes are 90V (FIG. 10A). At this time, a wall voltage shown in the diagram is generated between the X, Y, and A electrodes and the dielectric surfaces. At time b1 in the open period, the X-electrode voltage is 0V, so that the dielectric surface potential of the X electrode is −90V which corresponds to the wall voltage (FIG. 10B1). At time b2 in the open period, the X-electrode voltage becomes −V5=−60V, so that the dielectric surface potential of the X-electrode becomes −150V (FIG. 10B2). At this time, the potential difference between the X and Y electrodes and the dielectric surface becomes 240V which is higher than the firing voltage (about 230V). The potential difference between the dielectric surfaces of the X and A electrodes becomes 240V which is higher than the firing voltage (about 210V). Thus, the pre-discharge of the discharge among the three electrodes of the X, Y, and A electrodes occurs (P). After that, because of decrease in the wall voltage in the dielectric surfaces of the X, Y, and A electrodes by the pre-discharge and a change in voltage of the X electrode, the discharge is weakened once. At time c, as a result of the pre-discharge, the electrode wall voltages decrease as shown in FIG. 10C. In FIGS. 10A to 10C, the same part is designated by the same reference numeral as in FIGS. 8A to 8C.

On the other hand, a voltage of 180V is applied to the Y electrode, so that the dielectric surface potential of the Y electrode becomes 255V. The dielectric surface potential of the X electrode is −50V. As a result, the potential difference between the X and Y electrodes and the dielectric surface becomes 305V which is higher than the firing voltage (about 230V). Therefore, the main discharge (coplanar discharge) occurs between the dielectric surfaces of the X and Y electrodes (M). At this time, the wall voltage of the A-electrode is −25V, so that the potential of the A-electrode dielectric surface is 65V and no discharge occurs between the A and X electrodes. At this time, in reality, due to the priming effect of the pre-discharge P, a main discharge starts before time c at which the voltage of the Y electrode becomes the highest, so that a discharge occurs with a lower discharge space voltage. Both of the pre-discharge P and the main discharge M occur with a lower discharge space voltage as compared with the case of the conventional driving method. Since theultraviolet-production efficiency in the case of the discharge with the lower discharge space voltage is higher, the luminous efficiency of the PDP is therefore improved.

As described above, the coplanar discharge between the sustain-discharge electrode pair is brought about by the pre-discharge and is weakened once and, further, the main discharge occurs by using the priming effect of the pre-discharge. Since each of the discharges occurs with the lower discharge space voltage as compared with the conventional driving method, the ultraviolet-production efficiency increases.

Since the energy of ions incident on the dielectric surfaces of the X and Y electrodes becomes lower than that in the case of the conventional driving method, the life of the protective film made of MgO becomes longer.

Although the A electrode also contributes to a discharge in the pre-discharge, electrons are incident on the A electrode and there is no ion bombardment to the phosphor, and an adverse influence is hardly exerted to the life of the phosphor.

As described above, according to the driving method of the invention, the luminous efficiency is higher as compared with the conventional method, and the driving with less deterioration in life characteristic and the like can be performed.

Further, it is also advantageous that the driving can be performed by the driving method which is not largely different from the conventional one.

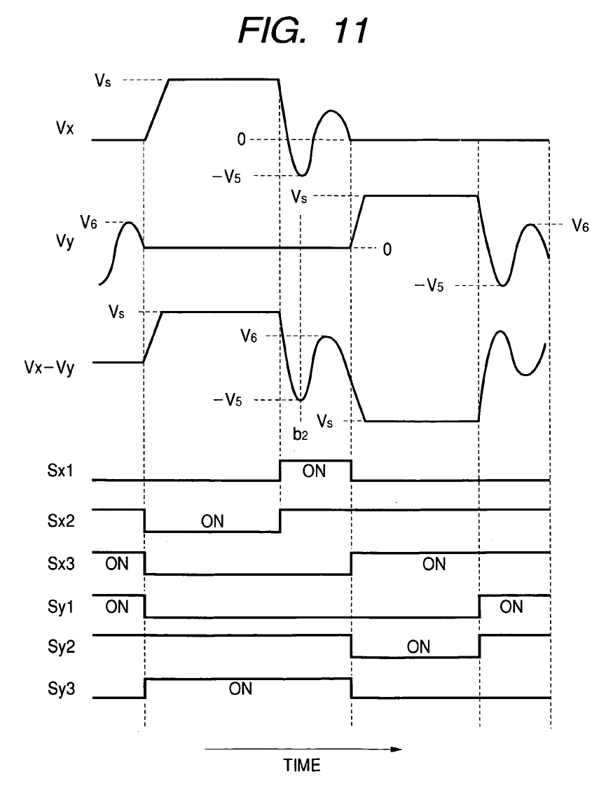

When the intensity of the pre-discharge is too strong, the main discharge does not occur. Consequently, the pre-discharge has to be suppressed to a proper intensity that the main discharge is not checked. FIG. 11 shows another example of the sustain-discharge pulse waveform of the embodiment of the invention in such a case. The waveform including an almost one cycle of damped oscillation during the open period is obtained by using the same circuit as that of FIG. 3 and choosing, as L, a value smaller than that in FIG. 1. At time b2 in FIG. 11, the pre-discharge occurs as at time b2 in FIG. 9. However, after start of the pre-discharge, Vx immediately increases to positive V6, so that the pre-discharge is suppressed before it becomes too strong. Consequently, the sustain discharge can be continued without checking the following main discharge. By adjusting the waveform in such a manner, the optimum pre-discharge of a wide operation margin can be achieved. Although the waveform including almost one cycle of the damped oscillation in the open period is used here, it is sufficient to select proper cycle and intensity in accordance with a case.

### Second Embodiment

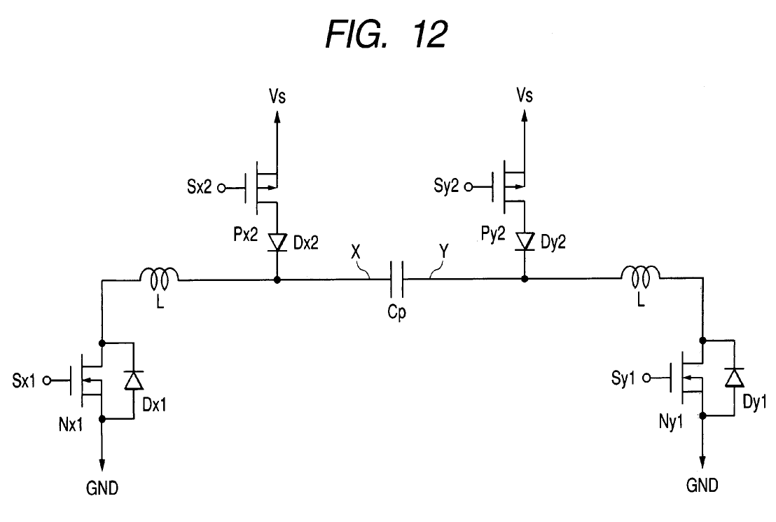

FIG. 12 shows an example of the sustain-discharge pulse generating circuit of a PDP of a plasma display device of a second embodiment of the invention. The X-electrode driving circuit has the P-type transistor Px2 connected to the voltage source Vs, N-type transistor Nx1 connected to the ground, inductance element L, and diodes Dx1 and Dx2. Similarly, the Y-electrode driving circuit has the P-type transistor Py2 connected to the voltage source Vs, N-type transistor Ny1 connected to the ground, inductance element L, and diodes Dy1 and Dy2.

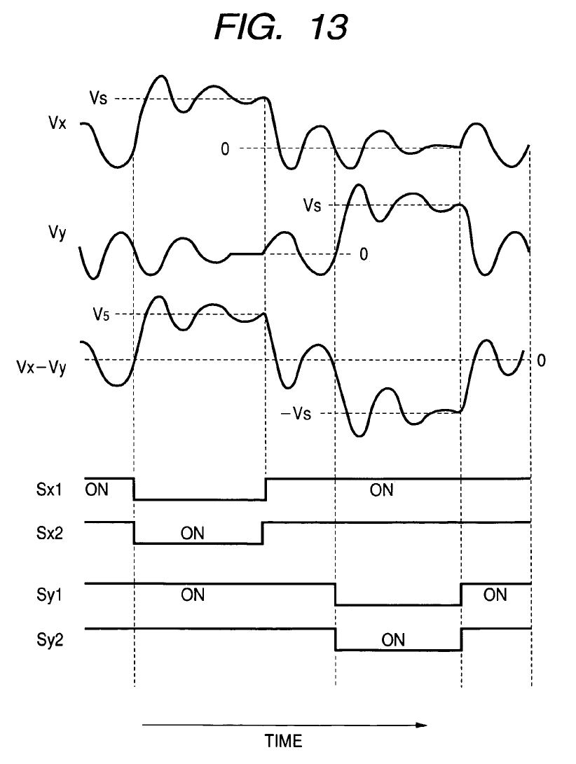

FIG. 13 shows an operation waveform of the sustain-drive pulse generating circuit of the second embodiment. Sx1, Sx2, Sy1, and Sy2 express waveforms of control signals. With reference to FIG. 13, the operation of the circuit of FIG. 12 will be described.

At time t1, Sx2 goes low and the transistor Px2 is made conductive and connected to the voltage source Vs via the diode Dx2. At this time, Sy1 goes high and the transistor Ny1 is made conductive and connected to the ground via the inductance element L. Therefore, by using R as a resistor in wiring or the like, the LCR series circuit of FIG. 5 is formed, and a damped oscillation occurs in Vx-Vy. At time t2, Sx1 goes high, and the transistor Nx1 is made conductive and connected to the ground via the inductance element L. At this time, Sy1 also goes high, and the transistor Ny1 is made conductive and connected to the ground via the inductance element L. Therefore, by using R as a resistor in wiring or the like, the LCR series circuit is formed, and Vx, Vy, and Vx-Vy have damped oscillation waveforms as shown in FIG. 13. The operations at time t3 and t4 are equal to those at time t1 and t2 except that X and Y are replaced with each other.

In this case as well, in a manner similar to the first embodiment, Vx-Vy has an overshoot waveform in the open period. By properly choosing an inductance value, the pre-discharge and the main discharge are brought about, and the luminous efficiency of the PDP can be improved.

As described above, in the embodiment, the inductance element L is just inserted to the conventional circuit, so that the circuit can be manufactured easily at low cost, and the luminous efficiency of the PDP can be improved.

### Third Embodiment

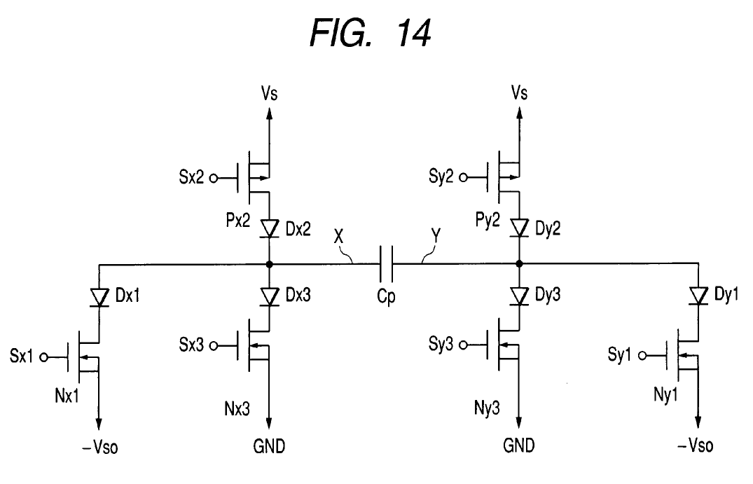

FIG. 14 shows an example of the sustain-discharge pulse generating circuit of a PDP of a plasma display device of a third embodiment of the invention. The third, fourth, and fifth embodiments do not use the inductance element L. The X-electrode driving circuit has the N-type transistor Nx1 connected to a voltage source Vso, the P-type transistor Px2 connected to the voltage source Vs, N-type transistor Nx3 connected to the ground, and diodes Dx1 to Dx3. Similarly, the Y-electrode driving circuit has the N-type transistor Ny1 connected to the voltage source Vso, the P-type transistor Py2 connected to the voltage source Vs, the N-type transistor Ny3 connected to the ground, and diodes Dy1 to Dy3.

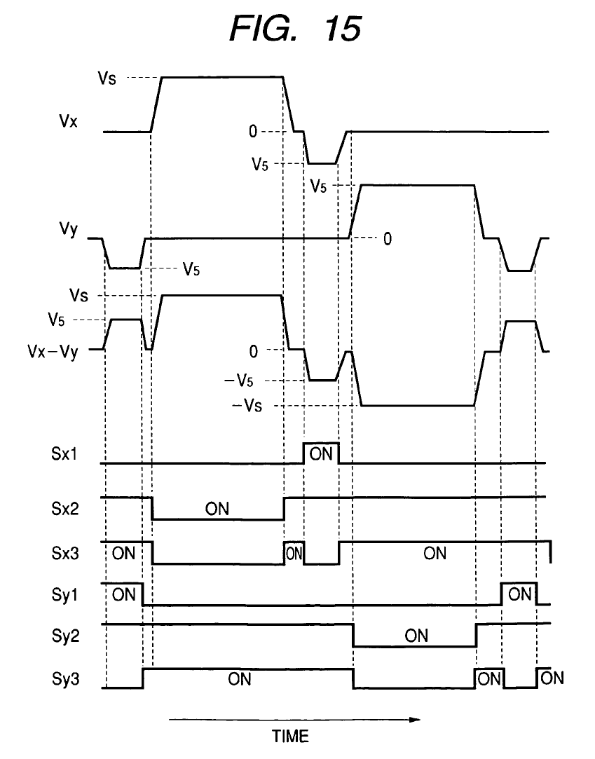

FIG. 15 shows an operation waveform of the sustain-drive pulse generating circuit of the third embodiment. Sx1 to Sx3 and Sy1 to Sy3 indicate waveforms of control signals. With reference to FIG. 15, the operation of the circuit of FIG. 14 will be described.

At time t1, the N-type transistor Ny1 is made conductive and connected to the voltage source Vso via the diode Dy1 and Vy is maintained at −V5. At this time, the N-type transistor Nx3 is made conductive and connected to the ground. At time t2, the transistor Ny1 is made non-conductive, and the transistor Ny3 is made conductive and connected to the ground, so that Vy becomes 0V. At time t3, the transistors Nx2 and Ny3 are made conductive, Vx becomes V3, and Vy is connected to the ground. The following operation is obvious from FIG. 15, so that its description will not be repeated.

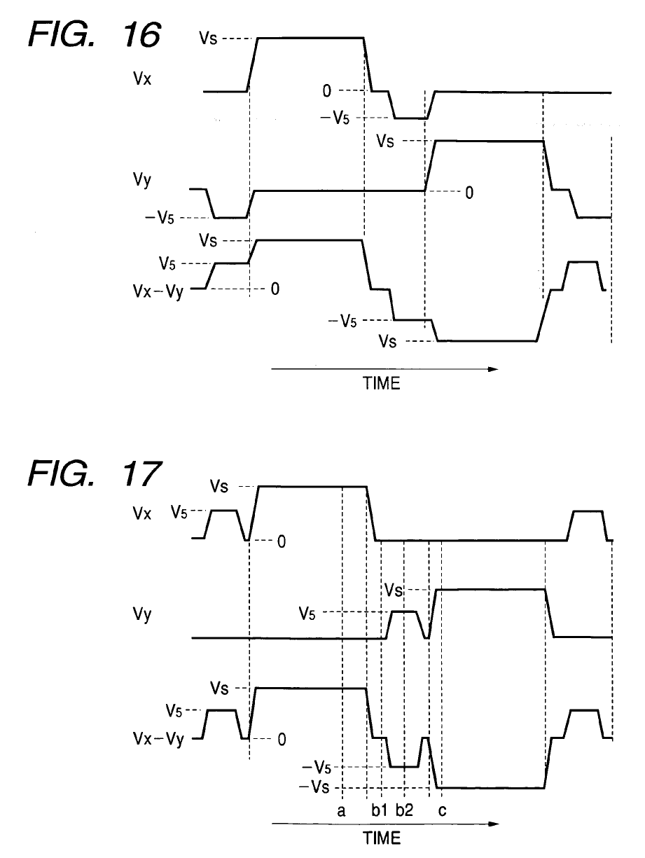

FIG. 16 shows the waveform of another sustain-discharge pulse voltage of the third embodiment of the invention. In the waveform of Vx-Vy, the voltage at a ±V5 level is directly shifted to the voltage at a ±Vs level.

In those cases as well, Vx-Vy has an overshoot waveform in the open period in a manner similar to the first embodiment, so that the pre-discharge and the main discharge occur, and the luminous efficiency of the PDP can be improved. In the embodiment, the sustain-discharge pulse waveform can be formed more freely with higher controllability as compared with the case of using the inductance element L.

### Fourth Embodiment

FIG. 17 shows an example of the waveform of a sustain-discharge pulse voltage of a PDP of a plasma display device of a fourth embodiment of the invention. The difference from the waveform of FIG. 15 of the third embodiment is that the voltage of V5 to be applied to the X and Y electrodes is positive. The waveform of Vx-Vy is the same as that of FIG. 15.

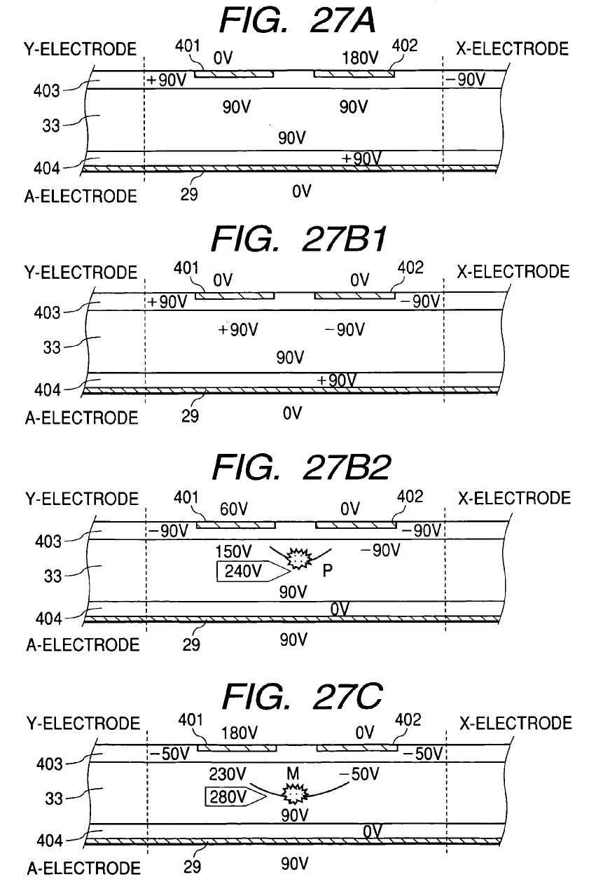

The discharge and the mechanism of improving the luminous efficiency will be described by using the diagrams of dielectric surface potential models of FIGS. 27A to 27C. FIGS. 27A to 27C show the states of the dielectric surface potential at time a, b1, b2, and c in FIG. 17. In a manner similar to the first embodiment, it is assumed that V3=180V, V5=60V, and the A-electrode voltage is a constant voltage of 90V. Until time a and b1, the states (FIGS. 27A and 27B1) are the same as those in FIGS. 10A and 10B1. At time b2 in the open period, the Y-electrode voltage becomes V5=60V, so that the dielectric surface potential of the Y electrode becomes 150V. At this time, the potential difference between the dielectric surfaces of the X and Y electrodes becomes 240V which is higher than the firing voltage (about 230V), so that the pre-discharge as a coplanar discharge between the X and Y electrodes occurs (P) (FIB. 27B2). Different from the example of FIGS. 10A to 10C, the potential difference between the dielectric surfaces of the X and A electrodes is 180V which is lower than the firing voltage (about 210V), so that a vertical discharge between the X and A electrodes does not occur. After that, due to drop in the wall voltage of the X, Y, and A electrode dielectric surfaces by the pre-discharge and a change in the voltage of the X electrode, the discharge is once weakened. At time c, as a result of the pre-discharge, the electrode wall voltages decrease as shown in FIG. 27C.

On the other hand, the voltage of 180V is applied to the Y electrode, so that the dielectric surface potential of the Y electrode becomes 230V. The dielectric surface potential of the X electrode is −50V. As a result, the potential difference between the dielectric surfaces of the X and Y electrodes becomes 280V which is higher than the firing voltage (about 230V). Therefore, the main discharge (coplanar discharge) occurs between the dielectric surfaces of the X and Y electrodes (M) Both of the pre-discharge P and the main discharge M occur with the lower discharge space voltage as compared with the case of the conventional driving method. Since higher ultraviolet-production efficiency is obtained by a discharge with the lower discharge space voltage, the luminous efficiency of the PDP improves.

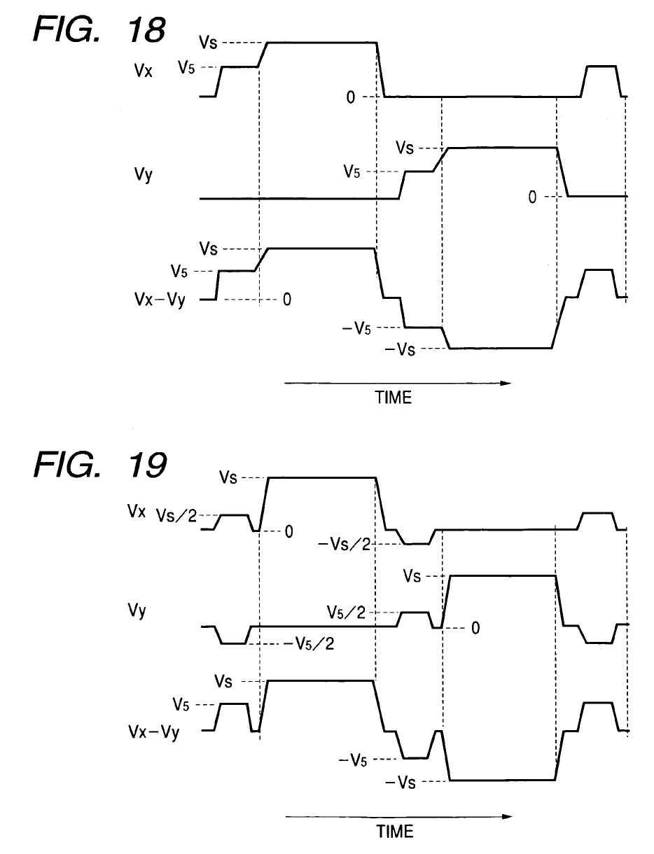

FIGS. 18 and 19 show examples of the sustain-discharge pulse voltage waveforms of the embodiment. Also in the case of the waveforms, an effect of improved luminous efficiency similar to the case of the waveform of FIG. 17 is produced.

In the fourth embodiment, the pre-discharge hardly includes the vertical discharge between the sustain-discharge electrode and the A electrode, so that no adverse influence is exerted on the life of the phosphor.

### Fifth Embodiment

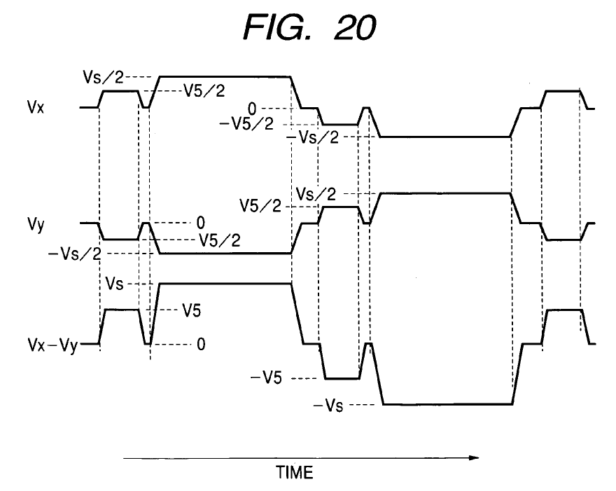

FIG. 20 shows the waveform of a sustain-discharge pulse voltage of a PDP of a plasma display device of a fifth embodiment of the invention. Although Vx and Vy are symmetrical with respect to the horizontal line, the waveform of Vx-Vy is the same as that in FIG. 17 of the fourth embodiment. In this case as well, a similar effect of improved luminous efficiency is produced.

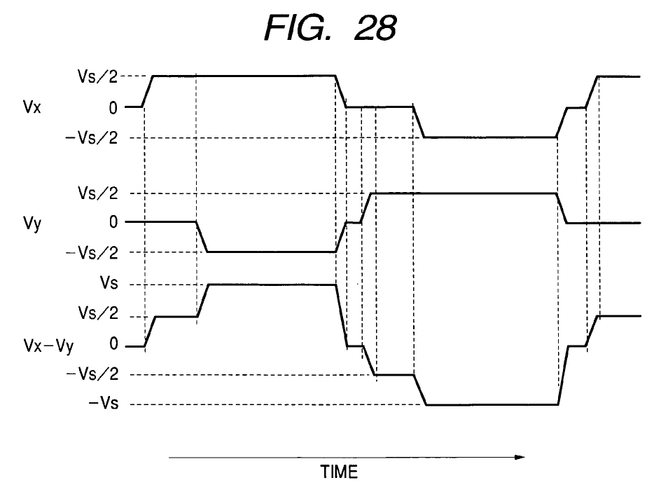

FIG. 28 shows a modification of the sustain-discharge pulse voltage waveform of the PDP of the plasma display device of the fifth embodiment of the invention. In this case as well, a similar effect of improved luminous efficiency is produced. There is also an advantage that the power source of V5 which is necessary in FIG. 20 is unnecessary.

Obviously, all of possible combinations of the foregoing embodiments can be carried out as the invention.

Although the invention has been specifically described in its preferred embodiments, obviously, the invention is not limited to the embodiments but can be variously modified without departing from its gist.

The invention provides the driving method which improves luminous efficiency of the plasma display panel. Further, in another embodiment of the invention, the invention can provide the plasma display device of higher luminous efficiency.

1-15. (canceled)

16. A method of driving a plasma display device having a plurality of discharge cells each including a first electrode and a second electrode, comprising the steps of:
executing a first discharge for supplying a first voltage of direct current to the first electrode to fix a potential difference between the first electrode and the second electrode to the first voltage,
executing a second discharge continuous with the first discharge, for supplying a second voltage of direct current to the first electrode after the first discharge to fix the potential difference between the first electrode and the second electrode to the second voltage into which the potential difference is expanded more than the first voltage,
executing a third discharge continuous with the first discharge and the second discharge, for supplying a third voltage of direct current to the second electrode to fix the potential difference between the first electrode and the second electrode to the third voltage, and
executing a fourth discharge continuous with the third discharge, for supplying a fourth voltage of direct current to the second electrode after the third discharge to fix the potential difference between the
first electrode and the second electrode to the fourth voltage into which the potential difference is expanded more than the third voltage.

17. The method of driving a plasma display device according to claim 16, wherein the second voltage and the fourth voltage differ with each other in polarity.

18. The method of driving a plasma display device according to claim 16, wherein the voltage of the second electrode is fixed while the first voltage and the second voltage are supplied to the first electrode, and the voltage of the first electrode is fixed while the third voltage and fourth voltage are supplied to the second electrode.

19. The method of driving a plasma display device according to claim 16, wherein the second voltage is supplied through switching over from the first voltage to the second voltage, and the fourth voltage is supplied through switching over from the third voltage to the fourth voltage.
